(19) United States
(12) Patent Application Publication
(10) Pub. No.: US 2021/0355843 A1
(43) Pub. Date: Nov. 18, 2021

(54) NACELLE FOR A GAS TURBINE ENGINE

(71) Applicant: ROLLS-ROYCE plc, London (GB)

(72) Inventors: Fernando L. TEJERO EMBUENA, Bedford (GB); David G. MACMANUS, Olney (GB); Christopher TJ. SHEAF, Derby (GB)

(73) Assignee: ROLLS-ROYCE plc, London (GB)

(21) Appl. No.: 17/231,460

(22) Filed: Apr. 15, 2021

(30) Foreign Application Priority Data
May 12, 2020 (GB) 2006961.3

(51) Int. Cl. F01D 25/24

(52) U.S. Cl. CPC F01D 25/24; F05D 2240/14; F05D 2220/32

(57) ABSTRACT

A nacelle for a gas turbine engine includes a leading edge, a trailing edge and a longitudinal centre line along a length of the nacelle. A highlight radius (rₕᵢ) is defined as a radial distance between the longitudinal centre line and the leading edge. A trailing edge radius (rₜₑ) is defined as a radial distance between the longitudinal centre line and the trailing edge. A nacelle length (L_{nac}) is defined as an axial distance between the leading edge and the trailing edge. A ratio between the nacelle length (L_{nac}) and the highlight radius (rₕᵢ) is defined as R₁ (L_{nac}/rₕᵢ). The ratio R₁ is greater than or equal to 2.4 and less than or equal to 3.2. A ratio between the trailing edge radius (rₜₑ) and the highlight radius (rₕᵢ) is defined as R₂. The ratio R₂ is greater than or equal to 0.89 and less than or equal to 1.

### CROSS-REFERENCE TO RELATED APPLICATIONS

This specification is based upon and claims the benefit of priority from United Kingdom patent application number GB 2006961.3 filed on May 12th 2020, the entire contents of which are incorporated herein by reference.

### BACKGROUND

### Technical Field

The present disclosure relates to a nacelle, and in particular to a nacelle for a gas turbine engine.

### Description of the Related Art

A gas turbine engine typically includes a fan housed within a nacelle. Current gas turbine engines generally have a low specific thrust to keep noise at acceptable levels and to achieve low fuel consumption, because a low specific thrust helps to improve specific fuel consumption (SFC). This low specific thrust is usually achieved with a high bypass ratio. Therefore, as the specific thrust reduces, there is a concomitant increase in fan diameter. In order to accommodate a larger diameter fan, dimensions of the nacelle may have to be increased proportionally. This typically results in a nacelle having increased drag and mass. Increase in drag and mass of the nacelle may both result in an increase in fuel consumption.

### SUMMARY OF THE DISCLOSURE

In a first aspect, there is provided a nacelle for a gas turbine engine. The nacelle includes a leading edge, a trailing edge and a longitudinal centre line along a length of the nacelle. The further nacelle includes a highlight radius defined as a radial distance between the longitudinal centre line and the leading edge. The nacelle further includes a trailing edge radius defined as a radial distance between the longitudinal centre line and the trailing edge. The nacelle further includes a nacelle length defined as an axial distance between the leading edge and the trailing edge. A ratio between the nacelle length and the highlight radius is defined as R₁. The ratio R₁ is greater than or equal to 2.4 and less than or equal to 3.2 (2.4≤R₁≤3.2). A ratio between the trailing edge radius and the highlight radius is defined as R₂. The ratio R₂ is greater than or equal to 0.89 and less than or equal to 1 (0.89≤R₂≤1.00).

The ranges of the ratios R₁ and R₂, as described above, may define a design space. A nacelle designed using values of the ratios R₁ and R₂ belonging to the design space may reduce nacelle drag for certain cruise-type conditions of an aircraft including the nacelle. In some cases, the nacelle conforming to the design space may reduce nacelle drag when attached to an aircraft travelling at a speed of between about 0.83 Mach to about 0.87 Mach. In some cases, the nacelle conforming to the design space may reduce nacelle drag when attached to an aircraft travelling at a speed of about 0.85 Mach. The nacelle which has a design conforming to the design space may consequently reduce specific fuel consumption of the aircraft it is attached to.

In some embodiments, the ratio R₂ is greater than or equal to 0.93 and less than or equal to 1 (0.93≤R₂≤1.00).

In some embodiments, the ratio R₂ is related to the ratio R₁ according to the inequality: R₂≥−0.02×R₁+0.994.

In some embodiments, for the ratio R₁ greater than or equal to 2.4 and less than or equal to 2.7 (2.4≤R₁≤2.7), the ratio R₂ is related to the ratio R₁ according to the inequality: R₂≥−0.10×+1.21.

The ratios R₁ and R₂ that satisfy the above relationships may define a reduced design space. A nacelle designed using values of the ratios R₁ and R₂ belonging to the reduced design space may reduce nacelle drag for certain cruise-type conditions of an aircraft including the nacelle while being robust during certain off-design conditions, such as windmilling, massive separation, end-of-runway condition and engine-out condition at a high altitude. The nacelle may have reduced drag during cruise-type conditions as well as off-design conditions.

In some embodiments, the nacelle further includes a fan casing disposed downstream of the leading edge.

In some embodiments, the nacelle further includes a diffuser disposed between the leading edge and the fan casing.

In a second aspect, there is provided a gas turbine engine for an aircraft. The gas turbine engine includes the nacelle of the first aspect. The gas turbine engine further includes a fan received within the fan casing of the nacelle. The gas turbine engine further includes an engine core received within the nacelle.

In a third aspect, there is provided an aircraft including the gas turbine engine of the second aspect. The aircraft is travelling at a speed of about 0.83 Mach to about 0.87 Mach.

In some embodiments, the aircraft is travelling at a speed of about 0.85 Mach.

The aircraft including the nacelle may have reduced drag and lower specific fuel consumption during cruise-type conditions as well as off-design conditions. Further, the nacelle may be able to withstand severe off-design conditions.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

According to an aspect, there is provided an aircraft comprising a gas turbine engine as described and/or claimed herein. The aircraft according to this aspect is the aircraft for which the gas turbine engine has been designed to be attached.

According to an aspect, there is provided a method of operating a gas turbine engine as described and/or claimed herein.

According to an aspect, there is provided a method of operating an aircraft comprising a gas turbine engine as described and/or claimed herein.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2A is a schematic perspective view of a nacelle;

FIG. 2B is a schematic side sectional view of the nacelle;

FIG. 3 is a simplified schematic side view of a top half of the nacelle;

FIG. 4A is a graph illustrating a design space for multiple parameters of the nacelle according to an embodiment of the present disclosure;

FIG. 4B is a graph illustrating a design space for multiple parameters of the nacelle according to an embodiment of the present disclosure;

FIG. 4C is a graph illustrating a design space for multiple parameters of the nacelle according to an embodiment of the present disclosure;

FIG. 4D is a graph illustrating a design space for multiple parameters of the nacelle according to an embodiment of the present disclosure; and

FIG. 5 is a block diagram depicting an exemplary multi-objective optimisation process for designing a nacelle.

### DETAILED DESCRIPTION OF THE DISCLOSURE

Aspects and embodiments of the present disclosure will now be discussed with reference to the accompanying figures. Further aspects and embodiments will be apparent to those skilled in the art.

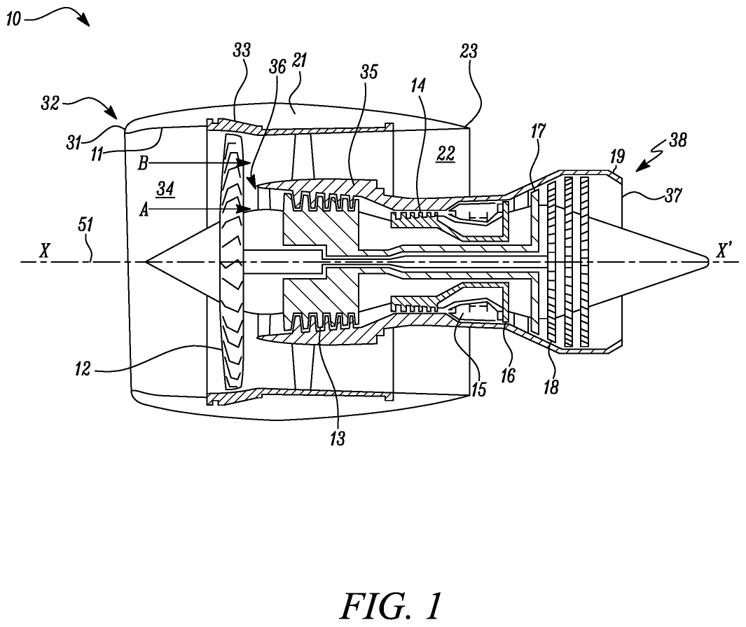

FIG. 1 shows a ducted fan gas turbine engine 10 having a principal rotational axis X-X′.

In the following disclosure, the following definitions are adopted. The terms “upstream” and “downstream” are considered to be relative to an air flow through the gas turbine engine 10. The terms “axial” and “axially” are considered to relate to the direction of the principal rotational axis X-X′ of the gas turbine engine 10.

The gas turbine engine 10 includes, in axial flow series, an intake 11, a fan 12, an intermediate pressure compressor 13, a high pressure compressor 14, combustion equipment 15, a high pressure turbine 16, an intermediate pressure turbine 17, a low pressure turbine 18 and an engine core exhaust nozzle 19. A nacelle 21 generally surrounds the gas turbine engine 10 and defines the intake 11, a bypass duct 22 and a bypass exhaust nozzle 23.

In some embodiments, the nacelle 21 is axisymmetric. In such cases, the principal rotational axis X-X′ of the gas turbine engine 10 may coincide with a longitudinal centre line 51 of the nacelle 21, as shown in FIG. 1. In some other embodiments, the nacelle 21 is non-axisymmetric. In such cases, the principal rotational axis X-X′ of the gas turbine engine 10 may not coincide with the longitudinal centre line 51 of the nacelle 21.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high pressure compressor 14 is directed into the combustion equipment 15 where it is mixed with fuel and the mixture combusted. The resultant hot combustion products then expand through, and thereby drive the high, intermediate and low pressure turbines 16, 17, 18 before being exhausted through the engine core exhaust nozzle 19 to provide additional propulsive thrust. The high, intermediate and low pressure turbines 16, 17, 18 respectively drive the high and intermediate pressure compressors 14, 13 and the fan 12 by suitable interconnecting shafts.

In some embodiments, the gas turbine engine 10 is used in an aircraft. In some embodiments, the gas turbine engine 10 is an ultra-high bypass ratio engine (UHBPR).

The nacelle 21 further includes an intake lip 31 disposed at an upstream end 32 of the nacelle 21, a fan casing 33 downstream of the intake lip 31, a diffuser 34 disposed between the upstream end 32 and the fan casing 33, and an engine casing 35 downstream of the intake lip 31. The fan 12 is received within the fan casing 33. An engine core 36 of the gas turbine engine 10 including the intermediate pressure compressor 13, the high pressure compressor 14, the combustion equipment 15, the high pressure turbine 16, the intermediate pressure turbine 17, the low pressure turbine 18 and the engine core exhaust nozzle 19 is received within the nacelle 21. Specifically, the engine core 36 is received within the engine casing 35. The nacelle 21 further includes an exhaust 37 disposed at a downstream end 38 of the nacelle 21. The exhaust 37 may be a part of the engine casing 35. The exhaust 37 may at least partly define the engine core exhaust nozzle 19.

The nacelle 21 for the gas turbine engine 10 is typically designed by manipulating various nacelle parameters. The selection of the nacelle parameters may be dependent on a speed (i.e., flight Mach number) of an aircraft the nacelle 21 is attached to, as well as considerations for integration of engine ancillaries, such as a thrust reversal unit (TRU). Optimisation of these nacelle parameters may be required to minimise drag incurred due to size and design of the nacelle 21.

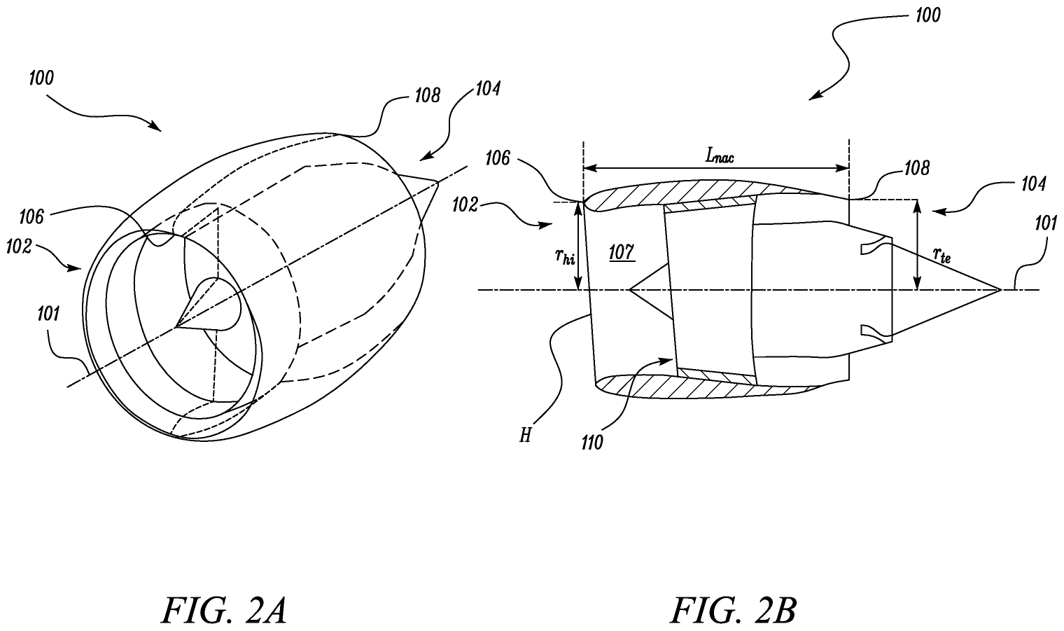

FIGS. 2A and 2B illustrate a nacelle 100 for the gas turbine engine 10, designed using various nacelle parameters. The nacelle 100 may be formed using any suitable material. For example, the nacelle 100 may formed as a metal forging, with the metal being selected from the group comprising steel, titanium, aluminium and alloys thereof. Optionally, the nacelle 100 may be formed from a fibre reinforced composite material, with the composite fibre being selected from the group comprising glass, carbon, boron, aramid and combinations thereof. An advantage of using a fibre reinforced composite material to form the nacelle 100 is that its weight may be reduced over a nacelle formed from a metallic material.

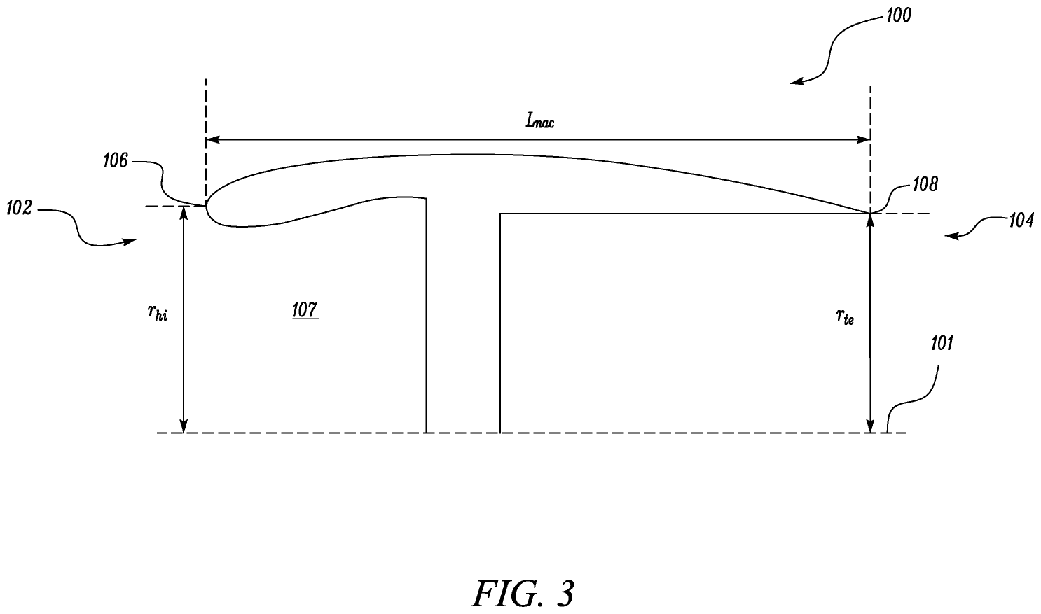

The nacelle parameters include at least a highlight radius rₕᵢ, a trailing edge radius rₜₑ and a nacelle length L_{nac}. The nacelle length L_{nac} and the trailing edge radius rₜₑ may have a first order impact on a feasible design for a nacelle of an ultra-high bypass ratio (UHBPR) engine. Various nacelle parameters have been depicted in FIGS. 2A and 2B. The nacelle 100 may also be optionally drooped and scarfed. The nacelle parameters will also be explained with reference to FIG. 3.

FIG. 3 illustrates a schematic side view of a top half of the nacelle 100 for the gas turbine engine 10 (shown in FIG. 1). The nacelle 100 depicted in FIG. 3 has been simplified for representing various nacelle parameters. Referring to FIGS. 2A, 2B and 3, the nacelle 100 includes a leading edge 106 disposed at an upstream end 102 of the nacelle 100. The nacelle 100 further includes a trailing edge 108 disposed at a downstream end 104 of the nacelle 100.

The nacelle 100 further includes a longitudinal centre line 101 along a length of the nacelle 100. In some embodiments, the longitudinal centre line 101 of the nacelle 100 may coincide with the principal rotational axis X-X′ of the gas turbine engine 10. In some embodiments, the longitudinal centre line 101 of the nacelle 100 may not coincide with the principal rotational axis X-X′ of the gas turbine engine 10.

The nacelle 100 further includes the nacelle length L_{nac} defined as an axial distance between the leading edge 106 and the trailing edge 108. The nacelle length L_{nac} is defined along the longitudinal centre line 101 of the nacelle 100.

The leading edge 106 defines a highlight surface H (see FIG. 2B). The highlight surface H is a locus of the leading edge 106. The highlight surface H includes the highlight radius rₕᵢ. Specifically, the nacelle 100 includes the highlight radius rₕᵢ defined as a radial distance between the longitudinal centre line 101 and the leading edge 106. The highlight radius rₕᵢ may vary azimuthally in the case of a non-axisymmetric nacelle.

In the case of an axisymmetric nacelle, the highlight surface H may generally be circular. In the case of a non-axisymmetric nacelle, the highlight surface H may have a non-axisymmetric curved shape, such as elliptical, depending on the azimuthal variation of the highlight radius rₕᵢ.

The nacelle 100 further includes the trailing edge radius rₜₑ defined as a radial distance between the longitudinal centre line 101 and the trailing edge 108. Similar to the highlight radius rₕᵢ, there may be azimuthal variation of the trailing edge radius rₜₑ in the case of a non-axisymmetric nacelle.

The nacelle 100 further includes a fan casing 110 disposed downstream of the leading edge 106. The fan 12 (shown in FIG. 1) of the gas turbine engine 10 may be received within the fan casing 110. The nacelle 100 further includes a diffuser 107 disposed between the leading edge 106 and the fan casing 110.

The diffuser 107 may be sized and configured for reducing velocity of air flow while increasing its static pressure.

A ratio (L_{nac}/rₕᵢ) between the nacelle length L_{nac} and the highlight radius rₕᵢ is defined as R₁. The ratio R₁ is therefore a dimensionless parameter related to the design of the nacelle 100. A ratio (rₜₑ/rₕᵢ) between the trailing edge radius rₜₑ and the highlight radius rₕᵢ is defined as R₂. The ratio R₂ is therefore a dimensionless parameter related to the design of the nacelle 100.

The ratio R₁ is therefore defined by Equation 1 given below.

R₁=L_{nac}/rₕᵢ Equation 1

The ratio R₂ is therefore defined by Equation 2 given below.

R₂=rₜₑ/rₕᵢ Equation 2

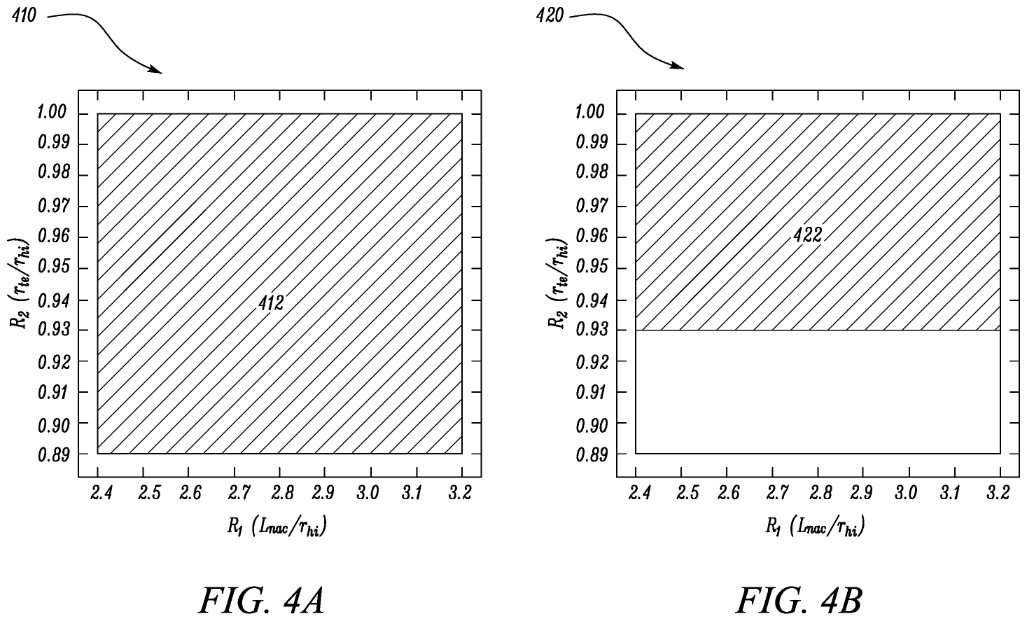

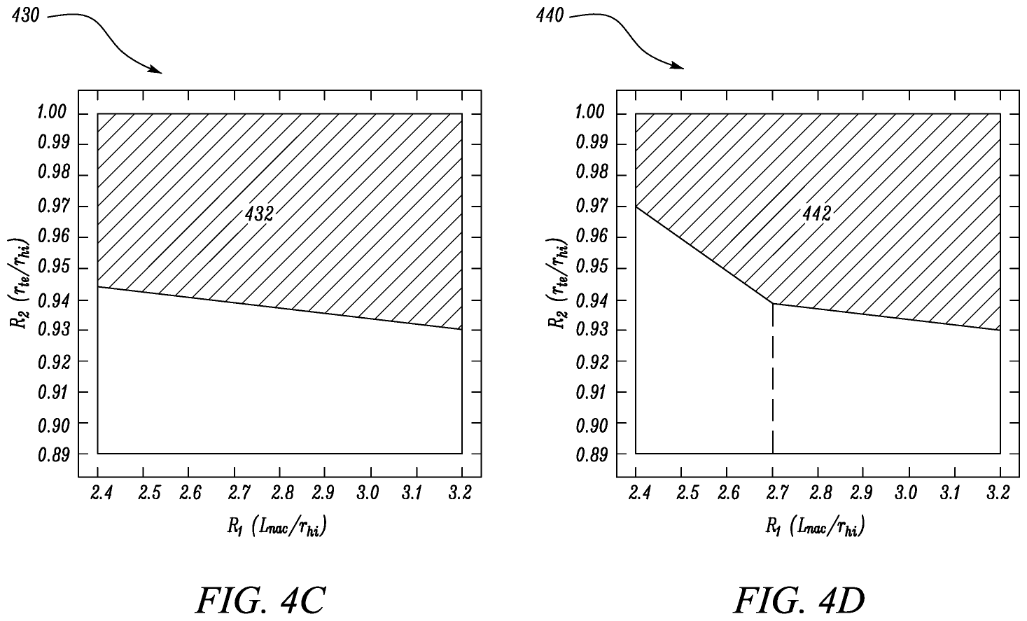

FIGS. 4A-4D illustrate graphs 410, 420, 430 and 440, respectively, depicting various design spaces of the ratios R₁ and R₂ for designing the nacelle 100. The design spaces may be determined by a multi-objective optimisation process (MOO). The ratio R₁ is shown along the ordinate (X-axis) and the ratio R₂ is shown along the abscissa (Y-axis) in each of the graphs 410, 420, 430 and 440. The suitable design spaces of the ratios R₁ and R₂ are depicted by respective hatched regions.

As depicted in the graph 410 of FIG. 4A, in some embodiments, the ratio R₁ is greater than or equal to 2.4 and less than or equal to 3.2. In some embodiments, the ratio R₂ is greater than or equal to 0.89 and less than or equal to 1.00. The ranges of the ratios R₁ and R₂ are defined mathematically by inequalities provided below.

2.4≤R₁≤3.2 Equation 3

0.89≤R₂≤1.00 Equation 4

The graph 410 shows a design space 412 (shown by a hatched region in FIG. 4A) that satisfies Equations 3 and 4. The design space 412 is substantially rectangular. For designing the nacelle 100, the ratios R₁ and R₂ are within the design space 412. Values of the highlight radius rₕᵢ, the trailing edge radius rₜₑ and the nacelle length L_{nac} may be determined from the design space 412 of the ratios R₁ and R₂. A nacelle designed using these values may be suitable for ultra-high bypass ratio (UHBPR) engines. A nacelle designed using these values may reduce nacelle drag for certain flight conditions. In some embodiments, the design space 412 may be feasible for cruise-type conditions of the aircraft including the nacelle 100. In some embodiments, the design space 412 may reduce nacelle drag when the nacelle 100 is attached to an aircraft travelling at a speed of about 0.83 Mach to about 0.87 Mach. In some embodiments, the design space 412 may reduce nacelle drag when the nacelle 100 is attached to an aircraft travelling at a speed of about 0.85 Mach. The nacelle 100 which has a design conforming to the design space 412 may consequently reduce specific fuel consumption of the aircraft it is attached to.

An embodiment of the nacelle 100 may be designed using a reduced range of the ratio R₂. The ratio R₁ remains greater than or equal to 2.4 and less than or equal to 3.2. The ratio R₂ is greater than or equal to 0.93 and less than or equal to 1.00. The reduced range of the ratio R₂ may be determined after a series of iterative steps of the multi-objective optimisation process. The ranges of R₁ and R₂ are defined mathematically by inequalities provided below.

2.4≤R₁≤3.2 Equation 5

0.93≤R₂≤1.00 Equation 6

The graph 420 shows a design space 422 (shown by a hatched region in FIG. 4B) that satisfies Equations 5 and 6. The design space 422 is substantially rectangular. The design space 422 has an area which is less than an area of the design space 412 shown in FIG. 4A. For designing the nacelle 100, the ratios R₁ and R₂ are within the design space 422. Values of the highlight radius rₕᵢ, the trailing edge radius rₜₑ and the nacelle length L_{nac} may be determined from the design space 422 of the ratios R₁ and R₂. A nacelle designed using these values may be suitable for ultra-high bypass ratio (UHBPR) engines. A nacelle designed using these values may reduce nacelle drag for certain flight conditions and certain off-design conditions. In some embodiments, the design space 422 may be feasible for cruise-type conditions of the aircraft including the nacelle 100. In some embodiments, the design space 422 may reduce nacelle drag when the nacelle 100 is attached to an aircraft travelling at a speed of about 0.83 Mach to about 0.87 Mach. In some embodiments, the design space 422 may reduce nacelle drag when the nacelle 100 is attached to an aircraft travelling at a speed of about 0.85 Mach. The nacelle 100 which has a design conforming to the design space 422 may consequently reduce specific fuel consumption of the aircraft it is attached to.

Iterative steps in the multi-objective optimisation process may further reduce the range of the ratio R₂ illustrated in the graph 430 of FIG. 4C. The ratio R₁ remains greater than or equal to 2.4 and less than or equal to 3.2. In some embodiments, the reduced range of ratio R₂ is used to design the nacelle 100. The ratio R₂ is greater than or equal to a straight line defined by (−0.02×R₁+0.994). Further, R₂ is less than or equal to 1.00 since R₂ has to conform to the design space 412 of FIG. 4A. The ranges of the ratios R₁ and R₂ are defined mathematically by inequalities provided below.

2.4≤R₁≤3.2 Equation 7

−0.02×R₁+0.994≤R₂≤1.00 Equation 8

The graph 430 shows a design space 432 (shown by a hatched region in FIG. 4C) that satisfies Equations 7 and 8. The design space 432 is substantially trapezoidal as the straight line that defines a lower boundary of the design space 432 has a non-zero slope of −0.02. The design space 432 has an area which is less than the area of the design space 422 shown in FIG. 4B. For designing the nacelle 100, the ratios R₁ and R₂ are within the design space 432. Values of the highlight radius rₕᵢ, the trailing edge radius rₜₑ and the nacelle length L_{nac} may be determined from the design space 432 of the ratios R₁ and R₂. A nacelle designed using these values may be suitable for ultra-high bypass ratio (UHBPR) engines. A nacelle designed using these values may reduce nacelle drag for certain flight conditions and off-design conditions. In some embodiments, the design space 432 may be feasible for cruise-type conditions of the aircraft including the nacelle 100. In some embodiments, the design space 432 may reduce nacelle drag when the nacelle 100 is attached to an aircraft travelling at a speed of about 0.83 Mach to about 0.87 Mach. In some embodiments, the design space 432 may reduce nacelle drag when the nacelle 100 is attached to an aircraft travelling at a speed of about 0.85 Mach. The nacelle 100 which has a design conforming to the design space 432 may consequently reduce specific fuel consumption of the aircraft it is attached to.

In some embodiments, the nacelle 100 is designed using a further reduced range of the ratio R₂. The reduced range of R₂ may consider off-design conditions, such as windmilling and massive separation. Off-design conditions may also include an end-of-runway condition. In an example, such an off-design condition may occur when: an aircraft is travelling at a speed of about 0.25 Mach, an incidence angle is greater than 20 degrees, a Mass Flow Capture Ratio (MFCR) is less than 0.35, and an aircraft altitude is about 0 metres.

Off-design conditions may also include an engine-out condition at a high altitude. In an example, such an off-design condition may occur when: an aircraft is travelling at a speed of about 0.85 Mach, a Mass Flow Capture Ratio (MFCR) is less than 0.35, and an aircraft altitude is about 10668 metres.

An optimised range of the ratios R₁ and R₂ suitable for the aforementioned off-design conditions may be determined using the multi-objective optimisation process. A design space of the ratios R₁ and R₂ may be substantially reduced when such off-design conditions are considered. A design space 442 for the nacelle 100 considering such off-design conditions is illustrated in the graph 440 of FIG. 4D. Values of the highlight radius rₕᵢ, the trailing edge radius rₜₑ and the nacelle length L_{nac} may be determined from the ratios R₁ and R₂ belonging to the design space 442 (shown by a hatched region in FIG. 4D).

The ratio R₂ is greater than or equal to a straight line defined by (−0.1×R₁+1.21) for R₁ greater than or equal to 2.4 and less than or equal to 2.7. The ratio R₂ is greater than or equal to the straight line defined by (−0.02×R₁+0.994) for the ratio R₁ greater than 2.7 and less than or equal to 3.2. An upper limit of the ratio R₂ remains 1.00, i.e., the ratio R₂ is less than or equal to 1.00. The ratio R₁ remains greater than or equal to 2.4 and less than or equal to 3.2. The ranges of the ratios R₁ and R₂ are defined mathematically by inequalities provided below.

2.4≤R₁≤3.2 Equation 9

−0.1×R₁+1.21≤R₂≤1.00 for 2.4≤R₁≤2.7 Equation 10

−0.02×R₁+0.994≤R₂≤1.00 for 2.7<R₁≤3.2 Equation 11

The graph 440 shows the design space 442 that satisfies Equations 9, 10 and 11. The design space 442 is substantially pentagonal as the straight lines that define a lower boundary of the design space 442 has non-zero slopes of −0.1 and −0.02. The design space 442 has an area which is less than the area of the design space 432 shown in FIG. 4C. Further, the design space 442 has an area which is substantially less than the area of the design space 412 shown in FIG. 4A. For designing the nacelle 100, the ratios R₁ and R₂ are within the design space 442. Values of the highlight radius rₕᵢ, the trailing edge radius rₜₑ and the nacelle length L_{nac} may be determined from the design space 442 of the ratios R₁ and R₂. A nacelle designed using these values may reduce nacelle drag for certain flight conditions and the off-design conditions discussed above. In some embodiments, the design space 442 may be feasible for cruise-type conditions of the aircraft including the nacelle 100. In some embodiments, the design space 442 may reduce nacelle drag when the nacelle 100 is attached to an aircraft travelling at a speed of about 0.83 Mach to about 0.87 Mach. In some embodiments, the design space 442 may reduce nacelle drag when the nacelle 100 is attached to an aircraft travelling at a speed of about 0.85 Mach. The nacelle 100 which has a design conforming to the design space 442 may consequently reduce specific fuel consumption of the aircraft it is attached to.

Ultra-high bypass ratio (UHBPR) engines may present larger sensitivity to off-design conditions than conventional configurations. A nacelle designed using the design space 442 may be suitable for ultra-high bypass ratio (UHBPR) engines. Further, a nacelle designed using the ratios R₁ and R₂ belonging to the design space 442 may reduce nacelle drag during a flight speed of about 0.85 Mach, while being robust during severe off-design conditions, such as windmilling, massive separation, end-of-runway condition and engine-out condition at a high altitude.

FIGS. 4A to 4D therefore show progressively reduced design spaces for the ratios R₁ and R₂ that consider various off-design conditions in addition to cruise-type conditions.

An aircraft includes the gas turbine engine 10 with the nacelle 100 according to the present disclosure. In some embodiments, the aircraft is travelling at a speed of about 0.83 Mach to about 0.87 Mach. In some embodiments, the aircraft is travelling at a speed of about 0.85 Mach.

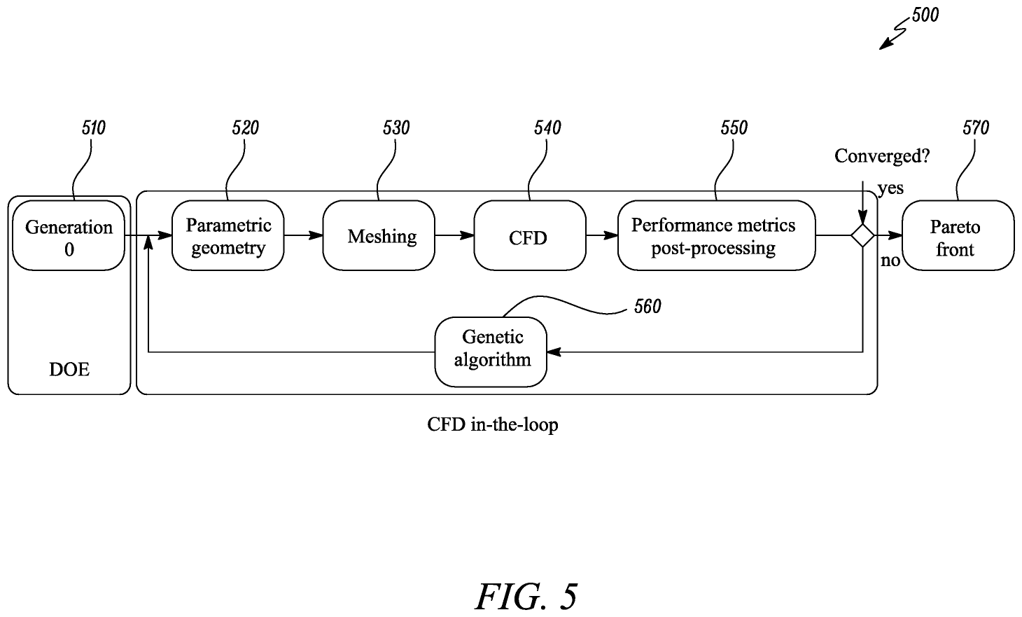

FIG. 5 illustrates an exemplary multi-objective optimisation (MOO) process 500 to obtain the design spaces 412, 422, 432 and 442 shown in FIGS. 4A, 4B, 4C, and 4D, respectively. At block 510, the MOO process 500 (hereinafter referred to as “the process 500”) starts with a design of experiments (DOE). The design of experiments (DOE) may be based on Latin Hypercube Sampling (LHS), due to its proven capabilities to efficiently cover high dimensional spaces. The use of the design of experiments (DOE) methodology may provide a means to identify critical process parameters which impact mid-cruise drag. At block 520, the nacelle designs obtained from the DOE are parametrised. The nacelle designs obtained from the DOE may be parameterised using an intuitive Class Shape Transformation (iCST) method with nacelle design parameters, such as highlight radius, maximum radius, nacelle length, trailing edge radius, etc. At block 530, a mesh generation tool is deployed to construct a fully structured 3-D mesh of the nacelle. At block 540, computational fluid dynamics (CFD) simulations of the meshed nacelle designs are carried out. The drag is extracted or computed with a developed thrust-drag bookkeeping method. At block 550, performance metrics post-processing is carried out. At block 560, a new set of nacelle design parameters are proposed by an evolutionary genetic algorithm (NSGA-II genetic algorithm) and evaluated using the describe approach. The loop from block 520 to block 560 continues until reaching convergence to a block 570 which is a Pareto front.

Optimisation of the design parameters using the process 500 define optimised nacelle parameters (i.e., the ratios R₁ and R₂) suitable for a nacelle of an aircraft. The nacelle 100 may preferably include an Ultra-High Bypass Ratio (UHBPR) engine, and the aircraft preferably travels at a speed in a region of 0.85 Mach.

In some embodiments, the nacelle 100 is used in an underwing-podded configuration. However, it should be noted that the present disclosure does not limit the nacelle 100 to be in an underwing-podded configuration. The present disclosure also does not limit the type of gas turbine engine used with the nacelle 100.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A nacelle for a gas turbine engine, the nacelle comprising:
a leading edge, a trailing edge and a longitudinal centre line along a length of the nacelle;
a highlight radius (rₕᵢ) defined as a radial distance between the longitudinal centre line and the leading edge;
a trailing edge radius (rₜₑ) defined as a radial distance between the longitudinal centre line and the trailing edge; and
a nacelle length (L_{nac}) defined as an axial distance between the leading edge and the trailing edge;
wherein a ratio between the nacelle length (L_{nac}) and the highlight radius (rₕᵢ) is defined as R₁ (L_{nac}/rₕᵢ), wherein 2.4≤R₁≤3.2; and
wherein a ratio between the trailing edge radius (rₜₑ) and the highlight radius (rₕᵢ) is defined as R₂ (rₜₑ/rₕᵢ), wherein 0.89≤R₂≤1.00.

2. The nacelle of claim 1, wherein 0.93≤R₂≤1.00.

3. The nacelle of claim 2, wherein R₂≥−0.02×R₁+0.994.

4. The nacelle of claim 3, wherein for 2.4≤R₁≤2.7, R₂≥−0.10×R₁+1.21.

5. The nacelle of claim 1, further comprising a fan casing disposed downstream of the leading edge.

6. The nacelle of claim 5, further comprising a diffuser disposed between the leading edge and the fan casing.

7. A gas turbine engine for an aircraft, the gas turbine engine comprising:
a nacelle according to claim 1;
a fan received within the fan casing of the nacelle; and
an engine core received within the nacelle.

8. An aircraft comprising a gas turbine engine according to claim 7, wherein the aircraft is travelling at a speed of about 0.83 Mach to about 0.87 Mach.

9. The aircraft of claim 8, wherein the aircraft is travelling at a speed of about 0.85 Mach.
